(19) United States
(12) Patent Application Publication
(10) Pub. No.: US 2017/0335756 A1
(43) Pub. Date: Nov. 23, 2017

(54) TURBOCHARGER WITH TWO-STAGE SERIES COMPRESSOR DRIVEN BY EXHAUST GAS-DRIVEN TURBINE AND ELECTRIC MOTOR

(71) Applicant: Honeywell International Inc., Morris Plains, NJ (US)

(72) Inventor: Gavin Donkin, Bellefontaine (FR)

(73) Assignee: Honeywell International Inc., Morris Plains, NJ (US)

(21) Appl. No.: 15/468,162

(22) Filed: Mar. 24, 2017

Related U.S. Application Data
(60) Provisional application No. 62/339,922, filed on May 22, 2016.

(51) Int. Cl. F02B 37/10; F04D 25/04; F04D 17/12; F02B 39/00; F02B 37/22; F04D 25/06; F02B 37/013

(52) U.S. Cl. CPC F02B 37/10; F04D 25/06; F04D 25/04; F02B 37/013; F02B 39/005; F02B 37/22; F04D 17/12

(57) ABSTRACT

A turbocharger includes a two-stage serial compressor having a first impeller and a second impeller affixed to a shaft and arranged in series for a two-stage compression of air, an exhaust gas-driven turbine having a turbine wheel affixed to the shaft, and an electric motor mounted on the shaft for assisting the turbine in rotatably driving the compressor.

### BACKGROUND

The present disclosure relates to exhaust gas-driven turbochargers that include an electric motor for providing supplementary motive power to the compressor.

Electric motor-driven turbochargers (“e-turbochargers”) face compromises in two respects. First, electric motors are mechanically challenged to run at the high speeds that turbochargers typically operate at, and accordingly it is frequently necessary to compromise the aerodynamic design of the compressor so that the compressor can operate at a lower speed in order for the electric motor to be able to survive. Alternatively, expensive motor technology is required in order to survive the high speeds.

Second, the compressor map width, which is the difference between the surge line and the choke line, is often a limiting factor in how the engine and turbocharger can be operated. With an e-turbo, this issue is exacerbated because when the motor is powered, the operating pressure ratio at a given engine speed is increased, thus pushing the compressor into surge.

### BRIEF SUMMARY OF THE DISCLOSURE

The present disclosure describes embodiments of an e-turbocharger having features that substantially mitigate the above-noted drawbacks of previous e-turbochargers. In accordance with one embodiment of the invention described herein, an e-turbocharger comprises a two-stage series compressor comprising a compressor housing assembly, and a compressor wheel comprising a first impeller and a second impeller that are mounted on a shaft for rotation therewith, the first and second impellers being contained in the compressor housing assembly, the compressor housing assembly defining a first compressor flow path including a first air inlet that leads air into the first impeller, a first volute that collects compressed air that has passed through and been compressed by the first impeller, a second compressor flow path including a second air inlet that leads air into the second impeller, and a second volute that collects compressed air that has passed through and been compressed by the second impeller, and further comprising an interstage duct that connects the first volute to the second air inlet such that air compressed by the first impeller is led by the interstage duct from the first volute into the second air inlet and is further compressed by the second impeller and delivered into the second volute.

The turbocharger further comprises an exhaust gas-driven turbine comprising a turbine housing defining an axial bore therein and a turbine wheel affixed to the shaft and contained in the axial bore of the turbine housing, the turbine housing defining a generally annular chamber arranged to receive exhaust gas, and a nozzle arranged to feed exhaust gas from the chamber generally radially inwardly to the turbine wheel, exhaust gas being discharged from the turbine housing via the axial bore.

The turbocharger further includes a center housing disposed between the compressor housing assembly and the turbine housing, the center housing containing one or more bearings for the shaft. In accordance with the invention, the turbocharger further comprises an electric motor comprising a generally annular motor stator concentrically surrounding a motor rotor, the motor rotor being affixed to the shaft, wherein energizing of the electric motor rotatably drives the motor rotor so as to assist the turbine wheel in rotatably driving the two-stage series compressor.

In accordance with the invention, coupling a two-stage series compressor with an electric motor mitigates the above-noted drawbacks of previous e-turbochargers that employ single-stage compression. A two-stage series compressor can achieve the desired pressure ratios at a lower speed than a single-stage compressor, and accordingly the severe mechanical challenges presented to the electric motor are substantially mitigated.

The present disclosure describes various embodiments of the invention. In accordance with one embodiment, the electric motor is disposed between the two-stage series compressor and the exhaust gas-driven turbine. The first and second impellers can be arranged in a back-to-back configuration.

The electric motor includes a motor housing containing the motor stator and the motor rotor, the motor housing defining coolant passageways for circulating a liquid coolant therethrough to cool the electric motor. In one embodiment an integral one-piece housing member forms both the center housing and the motor housing.

In another embodiment, the compressor housing assembly comprises a first compressor housing containing the first impeller and defining the first volute, and a separately formed second compressor housing containing the second impeller and defining the second volute, and the electric motor is disposed between the first compressor housing and the second compressor housing. The electric motor includes a motor housing containing the motor stator and the motor rotor, the motor housing being attached to the first compressor housing and to the second compressor housing. The motor housing can define coolant passageways for circulating a liquid coolant therethrough to cool the electric motor.

In the second embodiment the first compressor housing and first impeller can be arranged for air to enter the first impeller in a first axial direction, and the second compressor housing and second impeller can be arranged for air to enter the second impeller in a second axial direction that is opposite to the first axial direction.

In a third embodiment the electric motor is disposed upstream of the two-stage series compressor with respect to an axial direction in which air enters the first impeller. The shaft has a portion that extends upstream of the first impeller, and the motor rotor is mounted on said portion of the shaft. There is an annular space disposed between the motor stator and the motor rotor, and said annular space forms part of an air inlet through which air passes in said axial direction to enter the first impeller.

The exhaust gas-driven turbine in any or all of the embodiments can include a variable-nozzle assembly. As a non-limiting example, the variable-nozzle assembly can comprise an array of vanes disposed in the nozzle, the vanes being variable in setting angle for regulating exhaust gas flow into the turbine wheel.

### BRIEF DESCRIPTION OF THE SEVERAL VIEWS OF THE DRAWING(S)

Having thus described the present disclosure in general terms, reference will now be made to the accompanying drawings, which are not necessarily drawn to scale, and wherein:

FIG. 1 is an axial cross-sectional view of a turbocharger in accordance with a first embodiment of the invention;

FIG. 2 is an axial cross-sectional view of the turbocharger of FIG. 1 but taken on a different plane such that the interstage duct can be seen;

FIG. 3 is an axial cross-sectional view of a turbocharger in accordance with a second embodiment of the invention;

FIG. 4 is an axial cross-sectional view of a turbocharger in accordance with a third embodiment of the invention; and

FIG. 5 is an axial cross-sectional view of a turbocharger in accordance with a fourth embodiment of the invention.

### DETAILED DESCRIPTION OF THE DRAWINGS

The present invention now will be described more fully hereinafter with reference to the accompanying drawings in which some but not all embodiments of the invention are shown. Indeed, aspects of the invention may be embodied in many different forms and should not be construed as limited to the embodiments set forth herein; rather, these embodiments are provided so that this disclosure will satisfy applicable legal requirements. Like numbers refer to like elements throughout.

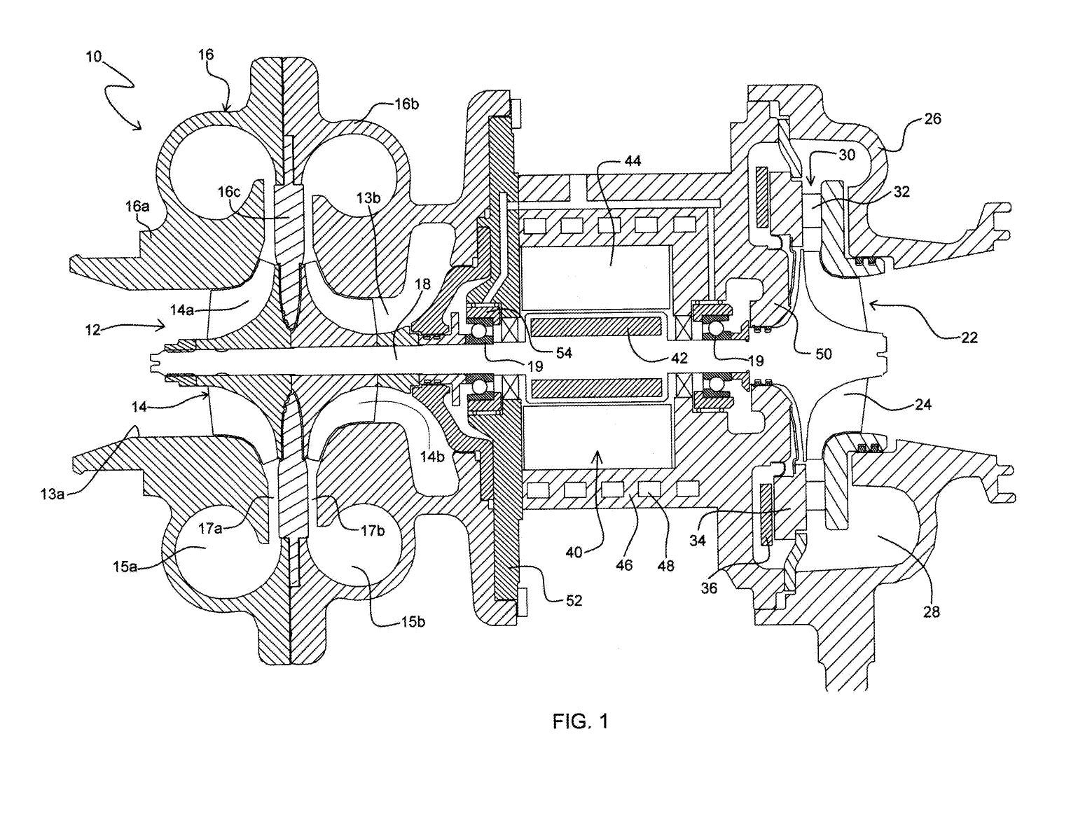

FIG. 1 illustrates an axial cross-sectional view of a turbocharger 10 in accordance with a first embodiment of the invention. The turbocharger includes a compressor 12 rotatably driven by an exhaust gas-driven turbine 22. The compressor 12 comprises a compressor wheel 14 affixed to a shaft 18 for rotation therewith. The compressor wheel is contained within a compressor housing assembly 16. The compressor wheel 14 is a twin-impeller wheel having a first impeller 14a and a second impeller 14b. In the illustrated embodiment, the first and second impellers are arranged in a back-to-back configuration such that air enters the first impeller 14a in an axial first direction (left-to-right in FIG. 1) and air enters the second impeller 14b in a second axial direction (right-to-left in FIG. 1) that is opposite to the first direction. The invention, however, is not limited to such a configuration, and the two impellers can instead be oriented in the same manner such that air enters each in the same axial direction.

The compressor housing assembly 16 in the illustrated embodiment comprises a first compressor housing 16a containing the first impeller 14a and a second compressor housing 16b containing the second impeller 14b. The first compressor housing 16a defines a first air inlet 13a for the first impeller, and also defines a first volute 15a that receives air that has passed through the first impeller and has been pressurized in a first stage of the two-stage compression process provided by the twin-impeller arrangement. The compressor housing assembly 16 also defines a first diffuser 17a through which air pressurized by the first impeller 14a is led radially outwardly and is diffused to a lower velocity and higher static pressure before it enters the first volute 17a.

The compressor housing assembly 16 further defines a second air inlet 13b for the second impeller 14b, a second volute 17b that receives air pressurized by the second impeller, and a second diffuser 17b that diffuses the air pressurized by the second impeller and discharges it into the second volute. In the illustrated embodiment, the compressor housing assembly comprises a separately formed, generally annular disk 16c disposed between the first compressor housing 16a and the second compressor housing 16b. One face of the disk 16c forms a wall of the first diffuser 17a and an opposite face of the disk forms a wall of the second diffuser 17b.

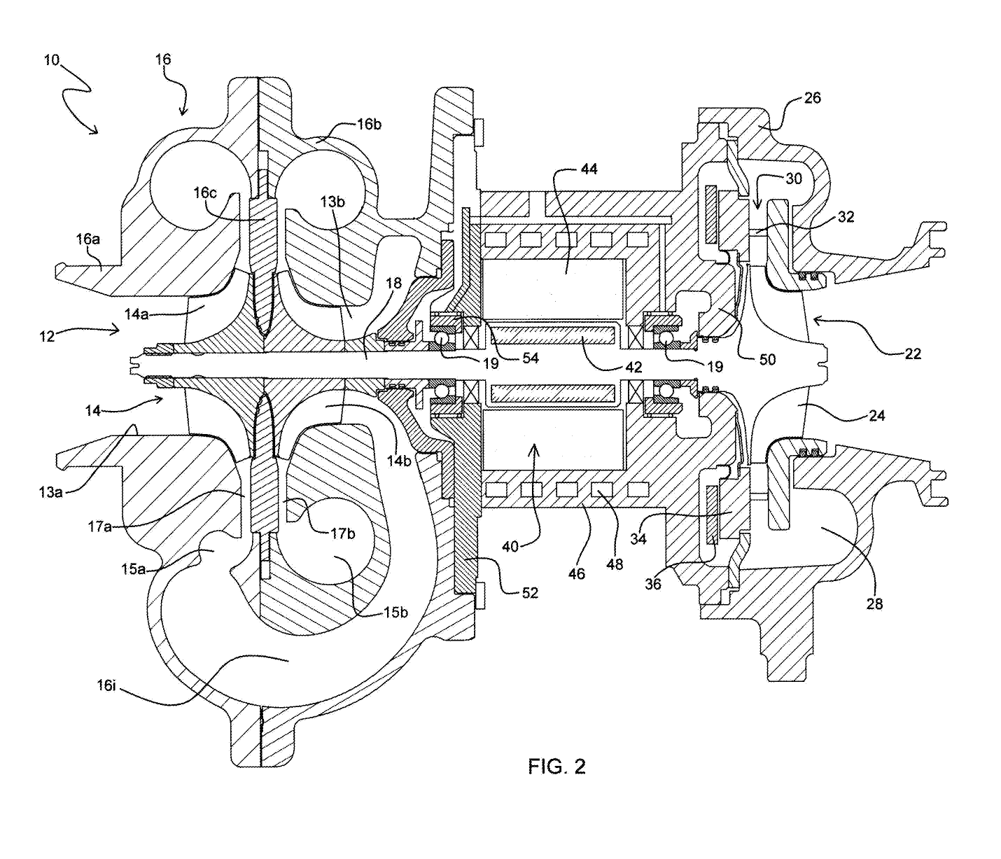

As shown in FIG. 2, the compressor housing assembly 16 further includes an interstage duct 161 that leads from the first volute 15a into the second air inlet 13b for the second impeller 14b. Thus, air that has been partially pressurized by the first impeller 14a is routed from the first volute 15a through the interstage duct 161 into the second air inlet 13b, and is further pressurized by the second impeller in a second stage of the two-stage compression process and is delivered into the second volute 15b for supply to the intake of an internal combustion engine.

Turning to the turbine 22, it comprises a turbine wheel 24 contained within a turbine housing 26. The turbine housing defines an exhaust gas inlet (not visible in FIG. 1) that receives exhaust gas from an internal combustion engine, and a generally annular chamber 28 that receives the exhaust gas from the inlet and distributes the gas around the 360-degree annular chamber. The turbine includes a nozzle 30 that leads exhaust gas from the chamber 28 generally radially inwardly into the turbine wheel 24. In the illustrated embodiment, the nozzle 30 is a variable nozzle having an array of variable vanes 32 rotatably mounted to a nozzle ring 34 and caused to pivot about their respective axes by rotation of a unison ring 36 disposed on the opposite side of the nozzle ring from the vanes.

In the first embodiment of the invention shown in FIG. 1, the turbocharger 10 includes an electric motor 40 disposed between the compressor 12 and the turbine 22. The electric motor comprises a motor rotor 42 affixed to the shaft 18 and a generally annular motor stator 44 concentrically surrounding the motor rotor 42. The motor stator is housed within a motor housing 46. The motor housing defines one or more coolant passages 48 for circulating a liquid coolant to cool the motor.

The turbocharger 10 also includes a center housing 50 that contains one or more bearings 19 as well as shaft seals for the shaft 18. In the embodiment of FIG. 1, the center housing 50 and the motor housing 46 are both formed by portions of an integral one-piece housing member, and the center housing contains one of two bearings 19 for the shaft. The other bearing 19 is held by an assembly comprising a generally annular bearing plate 52 and bearing carrier 54. The assembly of the bearing plate and bearing carrier is fastened between the motor housing 46 and the second compressor housing 16b.

The electric motor 40 will run on demand where the operating speed and boost pressure are lower than demanded speed/boost. These operating conditions mainly occur at low engine speeds and/or when changing from low load to increased load conditions. When the electric motor is not being powered to supply motive power to the shaft 18 of the turbocharger, the electric motor can operate as a generator to produce electrical power that can be used for various purposes in the vehicle, such as helping to charge a battery.

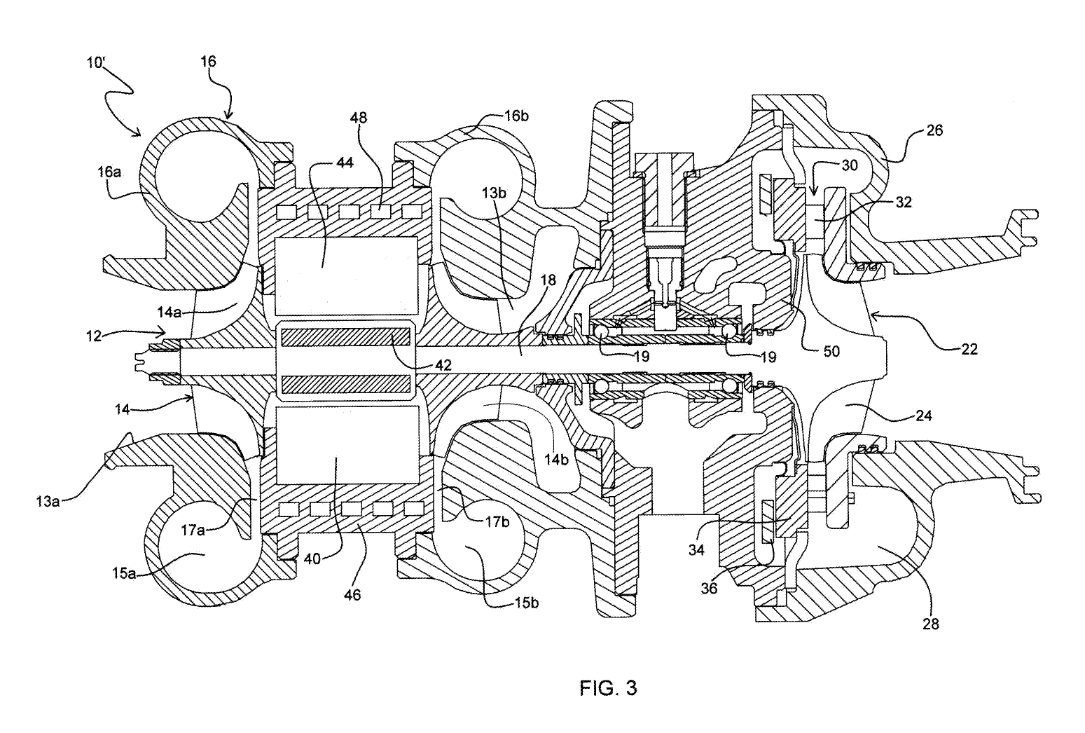

A turbocharger 10′ in accordance with a second embodiment of the invention is illustrated in FIG. 3. The turbocharger 10′ is similar in many respects to the turbocharger 10 described above, and accordingly the present description will focus primarily on those aspects of the turbocharger 10′ that differ from the first embodiment. In accordance with the second embodiment, the turbocharger 10′ includes a compressor 12 rotatably driven by an exhaust gas-driven turbine 22. The compressor 12 comprises a compressor wheel 14 affixed to a shaft 18 for rotation therewith. The compressor wheel is contained within a compressor housing assembly 16. The compressor wheel 14 is a twin-impeller wheel having a first impeller 14a and a second impeller 14b. In the illustrated embodiment, the first and second impellers are arranged in a back-to-back configuration such that air enters the first impeller 14a in an axial first direction (left-to-right in FIG. 3) and air enters the second impeller 14b in a second axial direction (right-to-left in FIG. 3) that is opposite to the first direction.

The compressor housing assembly 16 in the second embodiment comprises a first compressor housing 16a containing the first impeller 14a and a second compressor housing 16b containing the second impeller 14b. The first compressor housing 16a defines a first air inlet 13a for the first impeller, and also defines a first volute 15a that receives air that has passed through the first impeller and has been pressurized in a first stage of the two-stage compression process provided by the twin-impeller arrangement. The compressor housing assembly 16 also defines a first diffuser 17a through which air pressurized by the first impeller 14a is led radially outwardly and is diffused to a lower velocity and higher static pressure before it enters the first volute 17a.

The compressor housing assembly 16 further defines a second air inlet 13b for the second impeller 14b, a second volute 17b that receives air pressurized by the second impeller, and a second diffuser 17b that diffuses the air pressurized by the second impeller and discharges it into the second volute.

Similar to the arrangement shown in FIG. 2, the compressor housing assembly 16 further includes an interstage duct that leads from the first volute 17a into the second air inlet 13b for the second impeller 14b. Thus, air that has been partially pressurized by the first impeller 14a is routed from the first volute 17a through the interstage duct into the second air inlet 13b, and is further pressurized by the second impeller in a second stage of the two-stage compression process and is delivered into the second volute 17b for supply to the intake of an internal combustion engine.

Turning to the turbine 22, it comprises a turbine wheel 24 contained within a turbine housing 26. The turbine housing defines an exhaust gas inlet (not visible in FIG. 3) that receives exhaust gas from an internal combustion engine, and a generally annular chamber 28 that receives the exhaust gas from the inlet and distributes the gas around the 360-degree annular chamber. The turbine includes a nozzle 30 that leads exhaust gas from the chamber 28 generally radially inwardly into the turbine wheel 24. In the illustrated embodiment, the nozzle 30 is a variable nozzle having an array of variable vanes 32 rotatably mounted to a nozzle ring 34 and caused to pivot about their respective axes by rotation of a unison ring 36 disposed on the opposite side of the nozzle ring from the vanes.

In the second embodiment of the invention shown in FIG. 1, the turbocharger 10 includes an electric motor 40 disposed between the first impeller 14a and the second impeller 14b. More particularly, the electric motor comprises a motor housing 46 containing a motor stator 42 that surrounds a motor rotor 44 mounted on the shaft 18. The motor housing 46 is disposed between and fastened to the first compressor housing 16a and the second compressor housing 16b. The second compressor housing 16b is also fastened to one end of a center housing 50 that houses bearings 19 for the shaft 18. The other end of the center housing is fastened to the turbine housing 26. The motor housing 46 defines one or more coolant passages 48 for circulating a liquid coolant to cool the motor.

In the second embodiment, the first diffuser 17a is bounded between a face of the first compressor housing 16a and an opposing face of the motor housing 46, and the second diffuser 17b is bounded between a face of the second compressor housing 16b and an opposing face of the motor housing 46.

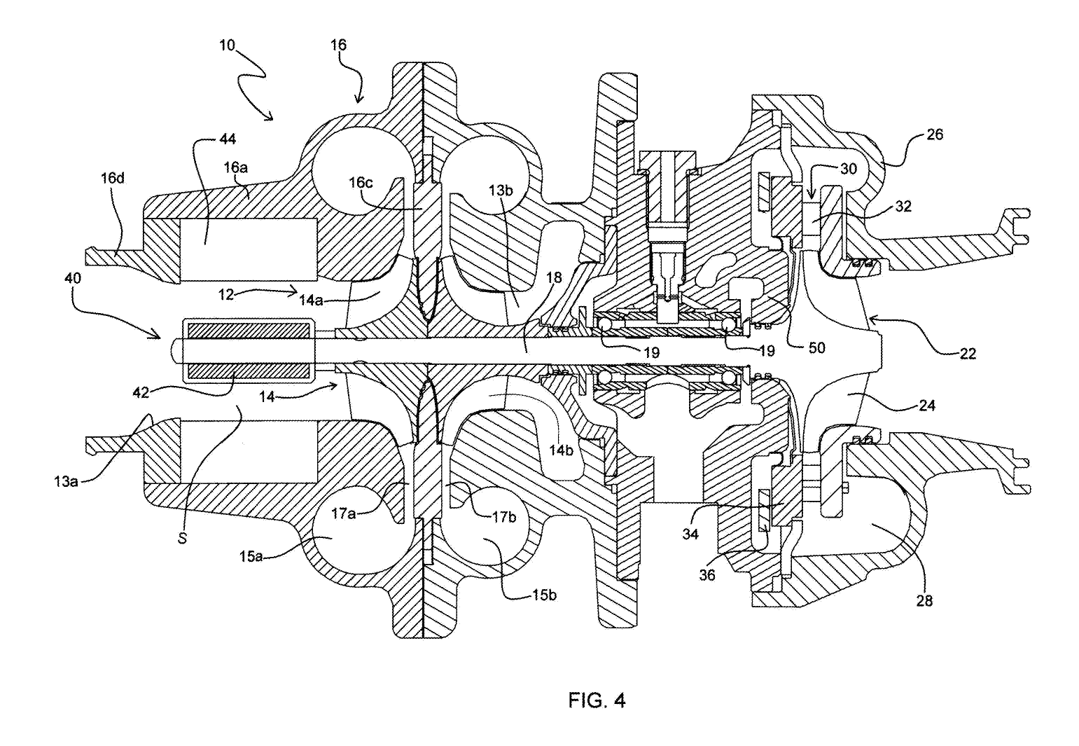

FIG. 4 illustrates a turbocharger 110 in accordance with a third embodiment of the invention. The third embodiment comprises many of the same or similar features as the first and second embodiments, and accordingly the present description will focus primarily on those aspects that differ from the first two embodiments described above. The chief difference between the turbocharger 110 and the turbocharger 10 is that the motor 40 of the turbocharger 110 is disposed upstream (with respect to the axial direction in which air enters the first impeller 14a) of the compressor 12. The first compressor housing 16a also serves as a motor housing for containing the motor stator 44. The motor rotor 42 is mounted on a portion of the shaft 18 that projects upstream from the first impeller 14a. The first inlet 13a for the first impeller 14a may be defined by a separately formed cap or plug 16d that is inserted into the first compressor housing 16a after the motor stator 44 has been installed therein. The plug 16d is generally annular or ring-shaped so that air can enter through its central passage in an axial direction and proceed into the first impeller. There is an annular space S disposed between the motor stator 44 and the motor rotor 42, and said annular space forms part of the air inlet through which air passes in the axial direction to enter the first impeller. The center housing 50 contains the bearings 19 for the shaft. In other respects the turbocharger 110 is substantially similar to the turbocharger 10 previously described.

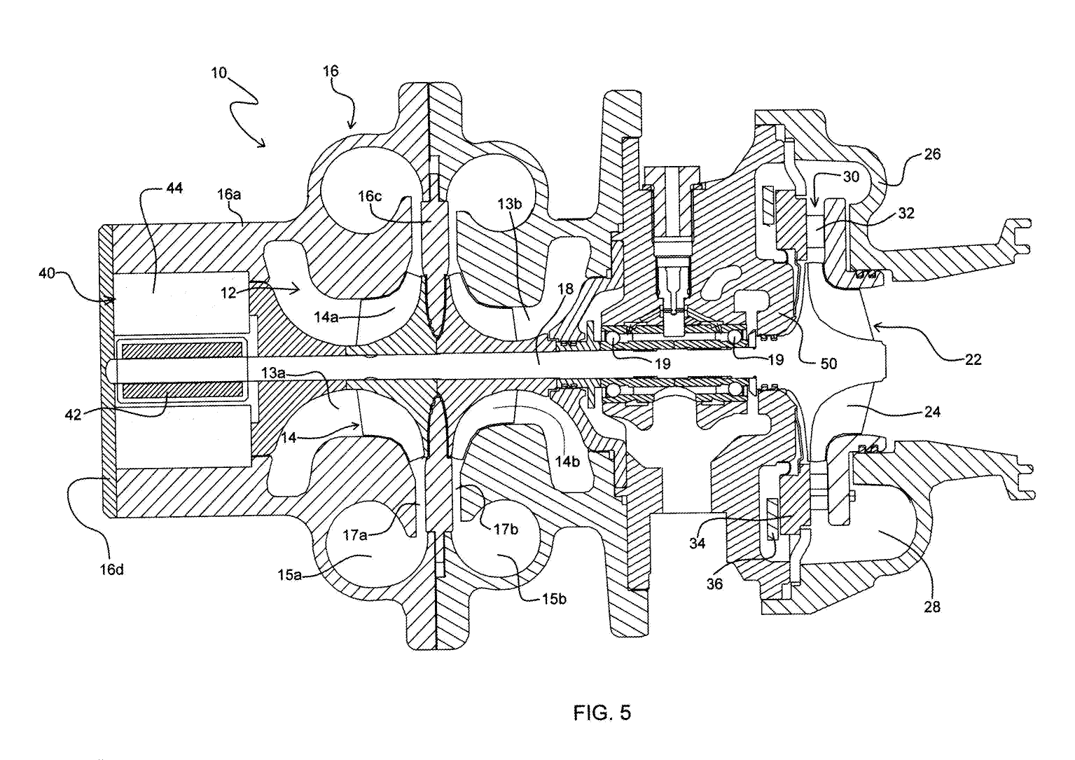

A turbocharger 210 in accordance with a fourth embodiment of the invention is now described with reference to FIG. 5. The turbocharger 210 is similar in many respects to the turbocharger 110, the chief difference being the manner in which air enters the first impeller 14a. The compressor housing assembly includes a cover 16d that closes off the front opening in the first compressor housing 16a such that the motor 40 is completely enclosed by the compressor housing assembly. Accordingly, air does not pass through the motor as in the above-described turbocharger 110. Instead, the compressor housing assembly includes a first inlet 13a that receives air via a conduit similar to the way that air is supplied to the second inlet 13b via an interstage duct. In other respects the turbocharger 210 is substantially similar to the turbocharger 110 previously described.

Many modifications and other embodiments of the inventions set forth herein will come to mind to one skilled in the art to which these inventions pertain having the benefit of the teachings presented in the foregoing descriptions and the associated drawings. For example, the invention can be practiced either with or without the use of an interstage cooler between the first and second compressor stages. Additionally, while back-to-back compressor impellers are illustrated in the drawings, the invention is not limited to such a configuration, and nose-to-tail compressor arrangements are within the scope of the invention. Furthermore, while the illustrated embodiments employ a variable-nozzle turbine, the invention is not limited to any particular turbine configuration; waste-gate and free-floating turbines can be used with the invention. Moreover, the invention is not limited to any particular order of arrangement of the compressor stages, the motor, the bearings, and the turbine along the axial direction. Thus, the invention encompasses arrangements such as the following non-limiting examples: (1) turbine|bearing|bearing|motor|compressor|compressor; (2) turbine|bearing|motor|bearing|compressor|compressor; (3) turbine|bearing|bearing|compressor|motor|compressor; (4) turbine|bearing|bearing|compressor|compressor|motor; (5) turbine|bearing|compressor|bearing|compressor|motor. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A turbocharger comprising:
a two-stage series compressor comprising a compressor housing assembly, and a compressor wheel comprising a first impeller and a second impeller that are mounted on a shaft for rotation therewith, the first and second impellers being contained in the compressor housing assembly, the compressor housing assembly defining a first compressor flow path including a first air inlet that leads air into the first impeller, a first volute that collects compressed air that has passed through and been compressed by the first impeller, a second compressor flow path including a second air inlet that leads air into the second impeller, and a second volute that collects compressed air that has passed through and been compressed by the second impeller, and further comprising an interstage duct that connects the first volute to the second air inlet such that air compressed by the first impeller is led by the interstage duct from the first volute into the second air inlet and is further compressed by the second impeller and delivered into the second volute;
an exhaust gas-driven turbine comprising a turbine housing defining an axial bore therein and a turbine wheel affixed to the shaft and contained in the axial bore of the turbine housing, the turbine housing defining an exhaust gas inlet for receiving exhaust gas, a generally annular chamber arranged to receive exhaust gas from the exhaust gas inlet, a nozzle arranged to feed exhaust gas from the chamber generally radially inwardly to the turbine wheel, exhaust gas being discharged from the turbine housing via the axial bore;
a center housing disposed between the compressor housing assembly and the turbine housing, the center housing containing one or more bearings for the shaft; and
an electric motor comprising a generally annular motor stator concentrically surrounding a motor rotor, the motor rotor being affixed to the shaft, wherein energizing of the electric motor rotatably drives the motor rotor so as to assist the turbine wheel in rotatably driving the two-stage series compressor.

2. The turbocharger of claim 1, wherein the electric motor is disposed between the two-stage series compressor and the exhaust gas-driven turbine.

3. The turbocharger of claim 2, wherein the first and second impellers are arranged in a back-to-back configuration.

4. The turbocharger of claim 2, wherein the electric motor includes a motor housing containing the motor stator and the motor rotor, the motor housing defining coolant passageways for circulating a liquid coolant therethrough to cool the electric motor.

5. The turbocharger of claim 4, wherein an integral one-piece housing member forms both the center housing and the motor housing.

6. The turbocharger of claim 1, wherein the compressor housing assembly comprises a first compressor housing containing the first impeller and defining the first volute, and a separately formed second compressor housing containing the second impeller and defining the second volute, and wherein the electric motor is disposed between the first compressor housing and the second compressor housing.

7. The turbocharger of claim 6, wherein the electric motor includes a motor housing containing the motor stator and the motor rotor, the motor housing being attached to the first compressor housing and to the second compressor housing.

8. The turbocharger of claim 7, wherein the motor housing defines coolant passageways for circulating a liquid coolant therethrough to cool the electric motor.

9. The turbocharger of claim 6, wherein the first compressor housing and first impeller are arranged for air to enter the first impeller in a first axial direction, and the second compressor housing and second impeller are arranged for air to enter the second impeller in a second axial direction that is opposite to the first axial direction.

10. The turbocharger of claim 1, wherein the electric motor is disposed upstream of the two-stage series compressor with respect to an axial direction in which air enters the first impeller, the shaft having a portion that extends upstream of the first impeller, and the motor rotor being mounted on said portion of the shaft.

11. The turbocharger of claim 10, wherein there is an annular space disposed between the motor stator and the motor rotor, and said annular space forms part of an air inlet through which air passes in said axial direction to enter the first impeller.

12. The turbocharger of claim 1, wherein the exhaust gas-driven turbine includes a variable-nozzle assembly.

13. The turbocharger of claim 12, wherein the variable-nozzle assembly comprises an array of vanes disposed in the nozzle, the vanes being variable in setting angle for regulating exhaust gas flow into the turbine wheel.
